(19) United States
(12) Patent Application Publication
(10) Pub. No.: US 2004/0034692 A1
(43) Pub. Date: Feb. 19, 2004

(54) Electronic mail server device and electronic mail processing method

(75) Inventors: Masashi Eguchi, Joyo-shi (JP); Yoshifumi Tanimoto, Osaka (JP)

Correspondence Address: ARMSTRONG, KRATZ, QUINTOS, HANSON & BROOKS, LLP, 1725 K STREET, NW, SUITE 1000, WASHINGTON, DC, 20006, US

(73) Assignee: Murata Kikai Kabushiki Kaisha, Kyoto-shi (JP)

(21) Appl. No.: 10/633,563

(22) Filed: Aug. 5, 2003

(30) Foreign Application Priority Data
Aug. 13, 2002 (JP) 2002-235756
Nov. 12, 2002 (JP) 2002-328349

(51) Int. Cl. G06F 15/16

(52) U.S. Cl. 709/206

(57) ABSTRACT

An electronic mail server device includes a reception unit which receives an electronic mail, a determination unit which determines whether a prescribed processing condition is satisfied in accordance with the received electronic mail, and a control unit which executes a prescribed processing to the received electronic mail when the processing condition is satisfied.

### FIELD OF THE INVENTION

The present invention relates to an electronic mail server device which receives an electronic mail and forwards the received electronic mail to a destination.

### DESCRIPTION OF THE RELATED ART

An Internet facsimile communication system which uses an Internet facsimile machine which transmits and receives image data via the Internet by using an electronic mail is proposed conventionally in the International Telecommunication Union-Telecommunications (ITU-T) Recommendation T.37. The Internet facsimile machine transmits an electronic mail which includes image data to an electronic mail server device (gateway device) of a receiving side via an electronic mail server device (gateway device) of a transmitting side and the Internet under a Simple Mail Transfer Protocol (SMTP) method. The Internet facsimile machine of the receiving side receives the electronic mail which includes the image data from the mail server device of the receiving side under the SMTP method or a Post Office Protocol 3 (POP3) method.

In the above-described Internet facsimile machine or the like, since there are special circumstances regarding a size, a format, etc. of the image data, there are cases when communication errors generate due to the size, the format, etc. of the image data or the electronic mail in a communication between the Internet facsimile machine and a general electronic mail server device or an electronic mail terminal device. That is, as long as a general electronic mail protocol is used, there are problems that it is necessary to ensure a smooth communication with the general electronic mail server device or the electronic mail terminal device.

### SUMMARY OF THE INVENTION

An advantage of the present invention is to solve the above-described problems, and to provide an electronic mail server device which can ensure a smooth communication with a general electronic mail server device for an electronic mail which is transmitted from an Internet facsimile machine or an electronic mail which the Internet facsimile machine is a destination.

The electronic mail server device of the present invention includes a reception unit which receives an electronic mail, and a determination unit which determines whether a prescribed processing condition is satisfied in accordance with the received electronic mail. In addition, the electronic mail server device includes a control unit which executes a prescribed processing to the received electronic mail when the processing condition is satisfied.

Thus, a smooth communication can be ensured between the Internet facsimile machine and a general electronic mail terminal device such as a personal computer.

Moreover, in the above-described electronic mail server device, the control unit receives data, which defines the processing condition and processing corresponding to the processing condition, from a remote device by using a prescribed communication protocol. Thus, the electronic mail server device can easily obtain and receive these data.

### BRIEF DESCRIPTION OF THE DRAWINGS

FIG. 1 is a block diagram showing a configuration of a communication system according to a first embodiment of the present invention.

FIG. 2 is a block diagram showing a configuration of an Internet facsimile machine 20A of FIG. 1.

FIG. 3 is a block diagram showing a configuration of an electronic mail server device 31 of FIG. 1.

FIG. 4 is a block diagram showing a configuration of a client personal computer 130A of FIG. 1.

FIG. 5 shows an example of a data conversion table 107a within a RAM 107 of FIG. 3.

FIG. 6 shows an example of a table of conditions and processing which is stored in the electronic mail server device 31 according to a second embodiment of the present invention.

FIG. 7 shows an example of a table of conditions and detailed contents of processing for each of destinations which is stored in the electronic mail server device 31 according to the second embodiment of the present invention.

### DETAILED DESCRIPTION OF THE PREFERRED EMBODIMENTS

Embodiments of the present invention will be described with reference to the accompanying drawings.

<First Embodiment>

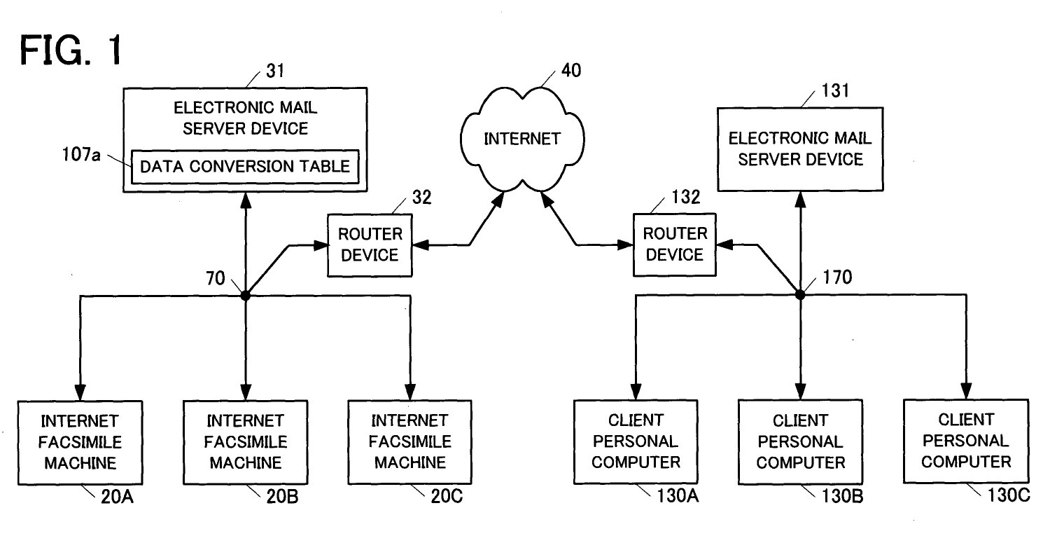

FIG. 1 is a block diagram showing a configuration of a communication system according to a first embodiment of the present invention, wherein a Local Area Network (LAN) 70 and a LAN 170 are connected via Internet 40. A plurality of Internet facsimile machines 20A, 20B, 20C are connected to the LAN 70, and a plurality of client personal computers 130A, 130B, 130C are connected to the LAN 170.

In the communication system of the present embodiment, a plurality of Internet facsimile machines 20A, 20B, 20C are connected to the LAN 70, and an electronic mail server device 31 is connected to the LAN 70. Meanwhile, a plurality of client personal computers 130A, 130B, 130C are connected to the LAN 170, and an electronic mail server device 131 is connected to the LAN 170.

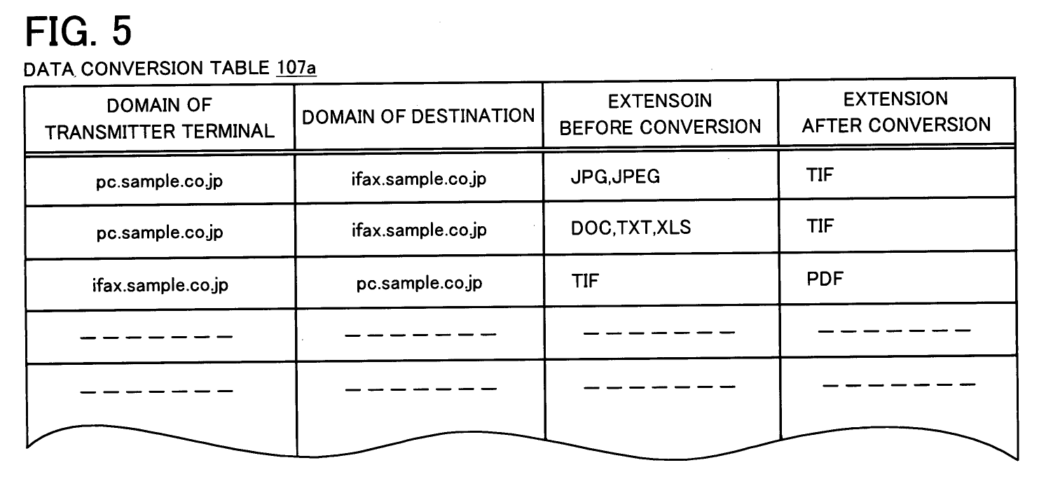

Here, the LAN 70 is connected to the LAN 170 via a router device 32, the Internet 40, and a router device 132. The electronic mail server device 31 receives an electronic mail, and forwards the received electronic mail to a destination. The electronic mail server device 31 includes a Random Access Memory (RAM) 107 which stores a data conversion table 107a shown in FIG. 5.

A main control unit 101 of the electronic mail server device 31 determines whether a domain or an electronic mail address of a transmitter terminal of the received electronic mail is a prescribed domain or a prescribed electronic mail address in accordance with the data conversion table 107a. When it is determined that the domain or the electronic mail address is the prescribed domain or the prescribed electronic mail address, the main control unit 101 executes conversion processing such as a format conversion or a filtering of an attached file of the received electronic mail, and forwards the electronic mail.

The mail control unit 101 also determines whether a domain of a destination or an electronic mail address of a destination of the received electronic mail is a prescribed domain or a prescribed electronic mail address in accordance with the data conversion table 107a. When it is determined that the domain or the electronic mail address of the destination is the prescribed domain or the prescribed electronic mail address, the main control unit 101 executes conversion processing such as a format conversion or a filtering of an attached file of the received electronic mail, and forwards the electronic mail.

Here, the domain and the electronic mail address of the transmitter terminal or the destination of the received electronic mail can be obtained from an electronic mail protocol or header information of the electronic mail.

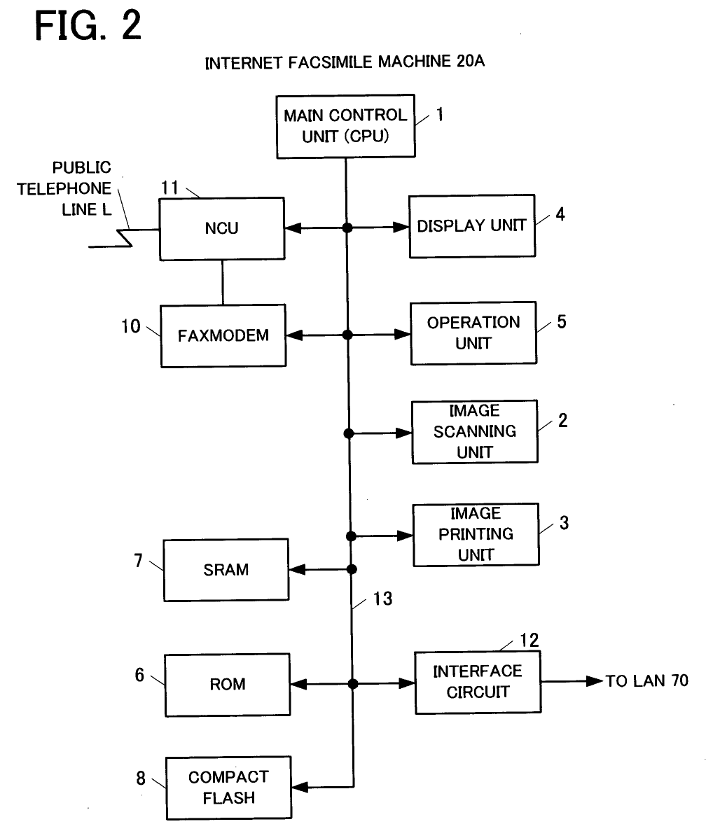

FIG. 2 is a block diagram showing a configuration of the Internet facsimile machine 20A of FIG. 1. Further, the Internet facsimile machines 20B, 20C of FIG. 1 also have a same configuration as the Internet facsimile machine 20A.

Referring to FIG. 2, the Internet facsimile machine 20A includes a facsimile communication function of a conventional G3 method or the like. The Internet facsimile machine 20A also includes an Internet facsimile communication function for transmitting and receiving image data by using an electronic mail via the Internet 40.

A main control unit 1 is specifically formed from a Central Processing Unit (CPU). The main control unit 1 is connected to each of following hardware units via a bus 13, and controls each of the connected hardware units. The main control unit 1 executes various software functions to be described later on.

An image scanning unit 2 scans an original document by a scanner using a Charge Coupled Device (CCD) or the like, and outputs dotted image data converted into a binary of black and white.

An image printing unit 3 is an electro-photographic typed printing device or the like. The image printing unit 3 prints out as a hardcopy, image data received by a facsimile communication from another facsimile machine or the like.

A display unit 4 is a displaying device such as a liquid crystal display or a Cathode Ray Tube (CRT) display or the like. The display unit 4 displays operational status of the Internet facsimile machine 20A, image data of an original document to be transmitted, and received image data.

An operation unit 5 includes letter keys, a ten-key numeric pad for dialing, speed-dial keys, one-touch dial keys, various function keys, a mouse or the like which are necessary for operating the Internet facsimile machine 20A. Further, by forming the display unit 4 as a touch panel, a part or all of the various keys of the operation unit 5 can be substituted.

A Read Only Memory (ROM) 6 stores in advance, various software programs which are necessary for the operation of the Internet facsimile machine 20A, and which are executed by the main control unit 1. These programs can be recorded in a recording medium such as a floppy disk, a Magneto Optic (MO) disk, a Digital Versatile Disk-Random Access Memory (DVD-RAM) or the like. When necessary, the programs can be loaded to a Static Random Access Memory (SRAM) 7 via a drive device, and the programs can be executed.

The SRAM 7 is used as a working area of the main control unit 1, and stores temporary data that generates when the program is executed.

A COMPACT FLASH 8 functions as a so-called image memory, and a memory as a program recording medium.

A faxmodem 10 is connected to a public telephone network 50 via a public telephone line L, and includes a function of a faxmodem for a G3 facsimile communication.

A Network Control Unit (NCU) 11 is a hardware circuit which carries out closing and releasing operation of a direct current loop of the public telephone line L, and which includes an automatic dial function. When necessary, the NCU 11 connects the faxmodem 10 to the public telephone line L. Further, a connection can be made to a digital line of a baseband transmission method (for example, an Integrated Services Digital Network (ISDN) line) via a terminal adaptor and a Digital Service Unit (DSU) to carry out a G4 facsimile communication.

An interface circuit 12 is an interface circuit which carries out a signal conversion of a signal or data or a protocol conversion for connecting the Internet facsimile machine 20A to a Local Area Network (LAN) 70 such as an ETHERNET or the like.

The Internet facsimile machine 20A of the present embodiment having the configuration as described above includes an Internet facsimile communication function in addition to the G3 facsimile communication function or the like.

In the facsimile communication function, the dotted image data scanned by the image scanning unit 2 is encoded in accordance with an encoding method such as Modified Huffman (MH), Modified Read (MR), Modified Modified Read (MMR) or the like, which are defined in a standard of the facsimile communication. Then, the encoded image data is transmitted to the facsimile machine of a destination. Meanwhile, encoded data received from the facsimile machine of the transmitting side is decoded into image data, and output as a hardcopy from the image printing unit 3.

Moreover, as shown in FIG. 1, the router device 32 and the router device 132 control delivery of packets in the Internet 40.

For example, when transmitting image data as an attached file of an electronic mail from the Internet facsimile machine 20A to a client personal computer 130A, first, the electronic mail is transmitted to the electronic mail server device 31 from the LAN interface 12 of FIG. 2 via the LAN 70. Then, the electronic mail is delivered from the electronic mail server device 31 to the client personal computer 130A of the destination via the LAN 70, the router device 32, the Internet 40, the router device 132, and the electronic mail server device 131 of the destination.

Meanwhile, when receiving an electronic mail, the electronic mail is received through a route that is the opposite of the route described above.

Here, a method for receiving the electronic mail from the electronic mail server device 31 can be either one of a Post Office Protocol (POP) 3 or a Simple Mail Transfer Protocol (SMTP). When using the POP 3, a mailbox is provided in a hard disk drive 108 of the electronic mail server device 31, and the Internet facsimile machines 20A, 20B, 20C access to the mailbox of the electronic mail server device 31 periodically under a prescribed period to receive an electronic mail. Moreover, when using the SMTP, the electronic mail server device 31 immediately transmits the received electronic mail to the Internet facsimile machines 20A, 20B, 20C of the destination, and in response to this, the Internet facsimile machines 20A, 20B, 20C receive the electronic mail. Further, a connection made to the Internet 40 is not limited to a private line or the like, and can be a dialup connection using the public telephone line L.

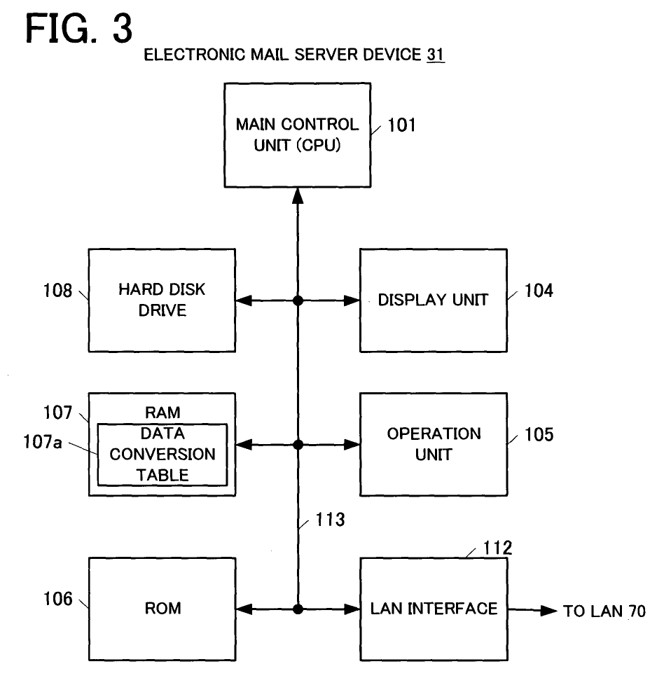

FIG. 3 is a block diagram showing a configuration of the electronic mail server device 31 of FIG. 1. Further, the electronic mail server device 131 of FIG. 1 also has the same configuration as the configuration shown in FIG. 3, but includes neither the data conversion table 107a nor a data conversion function based on the date conversion table 107a.

The electronic mail server device 31 shown in FIG. 3 is formed from a publicly known personal computer or server computer, and forwards an electronic mail. A main control unit 101 is specifically formed from a CPU. The main control unit 101 is connected to each of following hardware units via a bus 113, and controls each of the connected units. The main control unit 101 executes various software programs to be described later on.

In the electronic mail server device 31, a display unit 104 is a displaying device such as a liquid crystal display or a CRT display. The display unit 104 displays operational status of the electronic mail server device 31, image data of an original document to be transmitted, and received image data.

An operation unit 105 is a keyboard, a mouse or the like. The operation unit 105 is used for inputting character data or instruction command.

A ROM 106 stores in advance, various software programs which are necessary for an operation of the electronic mail server device 31, and which are executed by the main control unit 101.

Moreover, a RAM 107 is formed from an SRAM, a Dynamic Random Access Memory (DRAM), a Synchronous DRAM (SDRAM) or the like. The RAM 107 is used as a working area of the main control unit 101, and stores temporary data that generates when the programs are executed. Here, the RAM 107 includes the data conversion table 107a.

Furthermore, a hard disk drive 108 is a storage device which includes a recording medium, and stores an application program to be executed or image data.

A LAN interface 112 is connected to the LAN 70, and executes interface processing such as a signal conversion or a protocol conversion by receiving signal or data from the LAN 70 and transmitting signal or data to the LAN 70.

Further, a data conversion function based on the data conversion table 107a in the electronic mail server device 31 will be described later on.

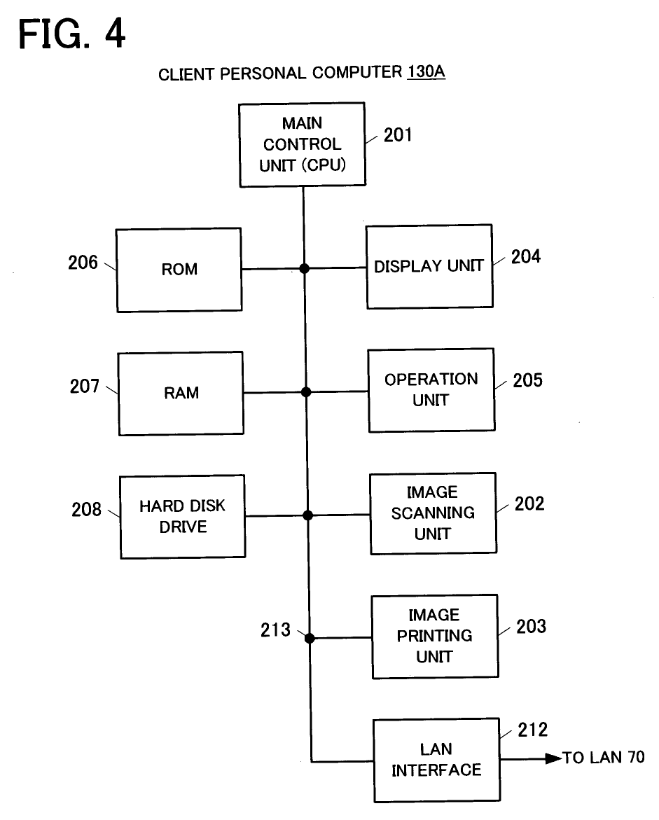

FIG. 4 is a block diagram showing a configuration of the client personal computer 130A of FIG. 1. Further, the client personal computers 130B, 130C of FIG. 1 also have the same configuration as the configuration shown in FIG. 4.

The client personal computer 130A shown in FIG. 4 is formed from a publicly known personal computer. The client personal computer 130A transmits and receives an electronic mail by the SMTP or the POP, and executes processing such as a generation processing or a print processing of image data or character data. In the present embodiment, the client personal computer 130A transmits or receives image data of a facsimile as an attached file of an electronic mail. In addition, the client personal computer 130A is used as a general electronic mail transmitting and receiving terminal device.

A main control unit 201 is specifically formed from a CPU. The main control unit 201 is connected to each of the following hardware units via a bus 213, and controls each of the connected units. The main control unit 201 executes various software functions to be described later on.

In the client personal computer 130A, an image scanning unit 202 and an image printing unit 203 are provided as an option. The image scanning unit 202 scans an original document by a scanner using a CCD or the like, and outputs dotted image data converted into a binary of black and white. The image printing unit 203 is an electro-photographic typed printing device or the like. The image printing unit 203 prints out image data received by a facsimile communication from the Internet facsimile machines 30A, 30B, 30C as a hardcopy, or records character data.

A display unit 204 is a displaying device such as a liquid crystal display or a CRT display. The display unit 204 displays an operational status of the client personal computer 130A, image data of an original document to be transmitted, and received image data.

An operation unit 205 is a keyboard, a mouse, or the like. The operation unit 205 is used for inputting character data or instruction command.

A ROM 206 stores in advance various software programs which are necessary for an operation of the client personal computer 130A, and which are executed by the main control unit 201.

Moreover, a RAM 207 is formed from an SRAM, a DRAM, an SDRAM or the like. The RAM 207 is used as a working area of the main control unit 201, and stores temporary data that generates when the program is executed.

Furthermore, a hard disk drive 208 is a storage device which includes a recording medium, and stores an application program to be executed and an image data.

A LAN interface 212 is connected to the LAN 170, and executes interface processing such as a signal conversion or a protocol conversion by receiving signal or data from the LAN 170, and transmitting signal or data to the LAN 170.

FIG. 5 shows an example of the data conversion table 107a stored in the RAM 107 of FIG. 3. As shown in FIG. 5, the data conversion table 107a includes “domain of transmitter terminal”, “domain of destination”, “extension before conversion” which indicates a format type of data before conversion, and “extension after conversion” which indicates a format type of data after conversion. In the following, a data conversion processing of the electronic mail server device 31 will be described in accordance with an example of the data conversion table 107a.

When a domain of a transmitter terminal of the received electronic mail is a domain “pc.sample.co.jp” (the domain of the client personal computers 130A, 130B, 130C), and a domain of a destination is a domain “ifax.sample.co.jp” (the domain of the Internet facsimile machines 20A, 20B, 20C), and extension before conversion of the file attached to the received electronic mail is JPG, JPEG which indicates a file of image data, DOC, TXT which indicate a document file, and XLS which indicates a spreadsheet file, the main control unit 101 of the electronic mail server device 31 converts data format of the attached file into TIF data file which can be used as image data easily in the facsimile machine. (Further, the letters of the extension are not limited to upper-case letters, and can be lower-case letters.) Then, the main control unit 101 attaches the converted file to an electronic mail, and forwards the electronic mail. Accordingly, the Internet facsimile machines 20A, 20B, 20C can print out the electronic mail without converting the data format.

On the contrary, when the domain of the transmitter terminal of the received electronic mail is the domain “ifax.sample.co.jp” (the domain of the Internet facsimile machines 20A, 20B, 20C), and the domain of the destination is the domain “pc.sample.co.jp” (the domain of the client personal computers 130A, 130B, 130C), and the extension before conversion of the file attached to the received electronic mail is TIF, the main control unit 101 converts data format of the attached file into a data file of a Portable Document Format (PDF), which is general image data file that can be displayed or printed easily by the client personal computer. Then, the main control unit 101 attaches the converted file to an electronic mail, and forwards the electronic mail. Accordingly, the client personal computers 130A, 130B, 130C can display or print out the electronic mail without converting the data format.

The example shown in FIG. 5 shows the domain of the transmitter terminal or the domain of the destination. However, the electronic mail address of the transmitter terminal or the electronic mail address of the destination can be designated instead. As a condition for executing the conversion processing of the data format, the condition can be defined such that the conversion processing is executed when the conditions of the transmitter terminal and the destination are satisfied, or instead, the condition can be defined such that the conversion processing is executed when the conditions of the transmitter terminal and the destination are not satisfied.

Furthermore, for example, when transmitting an electronic mail from the Internet facsimile machine 20A to the client personal computer 130A, the electronic mail server device 31 determines whether an amount of data of the received electronic mail exceeds a prescribed threshold value. When it is determined that the amount of data exceeds the prescribed threshold value, the electronic mail server device 31 controls to divide the received electronic mail into a prescribed size and to forward the divided electronic mails. The prescribed threshold value is determined in accordance with an ability of a communication terminal device or a mail server of a destination of forwarded electronic mails.

According to the above-described embodiment, when communicating with a general electronic mail server device or a general electronic mail terminal device which is not exclusive for an Internet facsimile communication, the electronic mail can be forwarded after being converted into a most appropriate file format or size for both sides of the communication.

<Second Embodiment>

In the Internet facsimile machines 20A, 20B, 20C, since image data is transmitted and received as an electronic mail, the size of the electronic mail is larger than a general electronic mail which does not include image data. Moreover, unlike the client personal computers 130A, 130B, 130C, a receiving ability of the Internet facsimile machines 20A, 20B, 20C is limited. Therefore, even when receiving electronic mails, there are many electronic mails which the Internet facsimile machines 20A, 20B, 20C cannot handle. In addition, antivirus software or the like for a protection against attack of virus, etc. cannot be installed to the Internet facsimile machines 20A, 20B, 20C. That is, an electronic mail environment formed from only the Internet facsimile machines 20A, 20B, 20C has many different natures from a general electronic mail environment. Therefore, by providing the electronic mail server device 31 for an Internet facsimile machine, the different natures can be absorbed. The electronic mail server device 31 for the Internet facsimile machine functions like a gateway which connects the electronic mail environment of the Internet facsimile machine and the general electronic mail environment.

Specifically, the electronic mail server device 31 is preferable to include following functions.

(1) The electronic mail server device 31 can define electronic mails which cannot be received by the Internet facsimile machines 20A, 20B, 20C. The electronic mail server device 31 analyzes an electronic mail received from a remote device, and can execute an error processing such as returning or forwarding of an electronic mail which cannot be received by the Internet facsimile machines 20A, 20B, 20C.

(2) The electronic mail server device 31 can define the receiving ability of the Internet facsimile machines 20A, 20B, 20C. The electronic mail server device 31 analyzes an electronic mail received from a remote device, and can convert the received electronic mail to meet the receiving ability of the terminals.

(3) The electronic mail server device 31 analyzes an electronic mail received from a remote device, and checks viruses or the like to eliminate an electronic mail which is determined to cause damages to the Internet facsimile machines 20A, 20B, 20C.

(4) The electronic mail server device 31 checks an electronic mail transmitted from the Internet facsimile machines 20A, 20B, 20C to the client personal computers 130A, 130B, 130C, and can divide an electronic mail which the size exceeds a threshold value set in advance.

(5) The electronic mail server device 31 can define the electronic mail address or the domain name of an electronic mail which the terminals of the Internet facsimile machines 20A, 20B, 20C permit the reception. When the electronic mail received from a remote device is not an electronic mail from a permitted address, the electronic mail server device 31 can block the reception of such an electronic mail. In other words, the electronic mail server device 31 provides a filtering function. In this case, the electronic mail server device 31 can prohibit a forwarding of such an electronic mail.

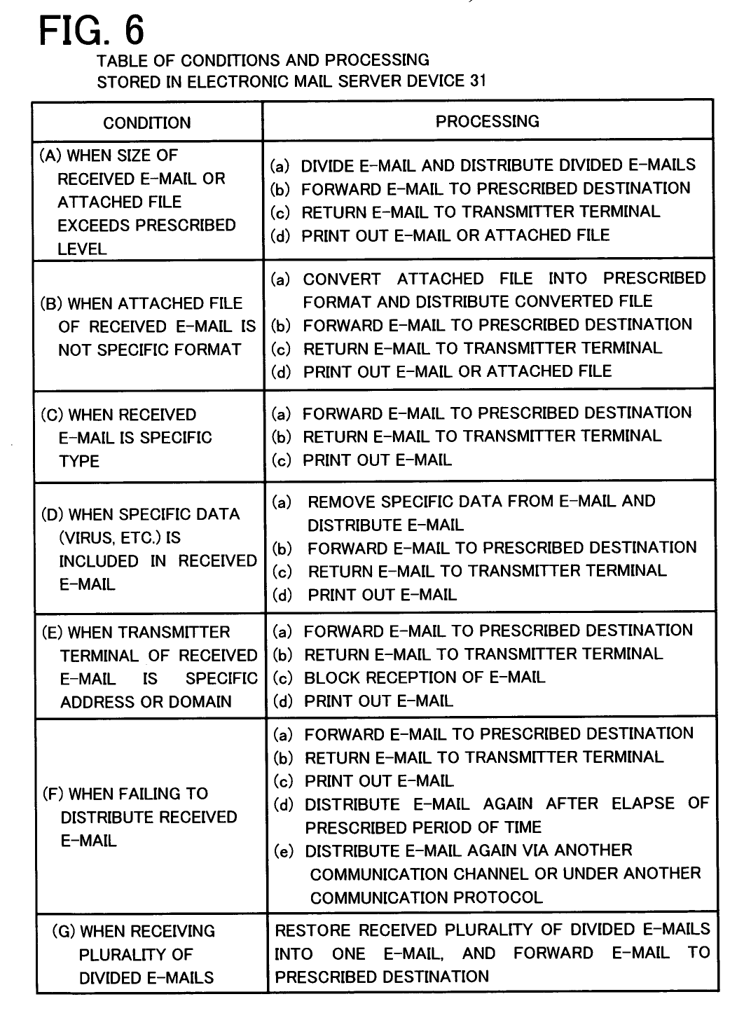

That is, in addition to the configuration of the first embodiment, the main control unit 101 of the electronic mail server device 31 of the second embodiment executes so-called filtering processing of an electronic mail. In the filtering processing, an electronic mail is received, and the received electronic mail is forwarded to a destination as a basic processing. In addition, it is determined whether a prescribed processing condition shown in FIG. 6 is satisfied in accordance with the received electronic mail, and when the processing condition is satisfied, a prescribed processing shown in FIG. 6 is executed to the received electronic mail.

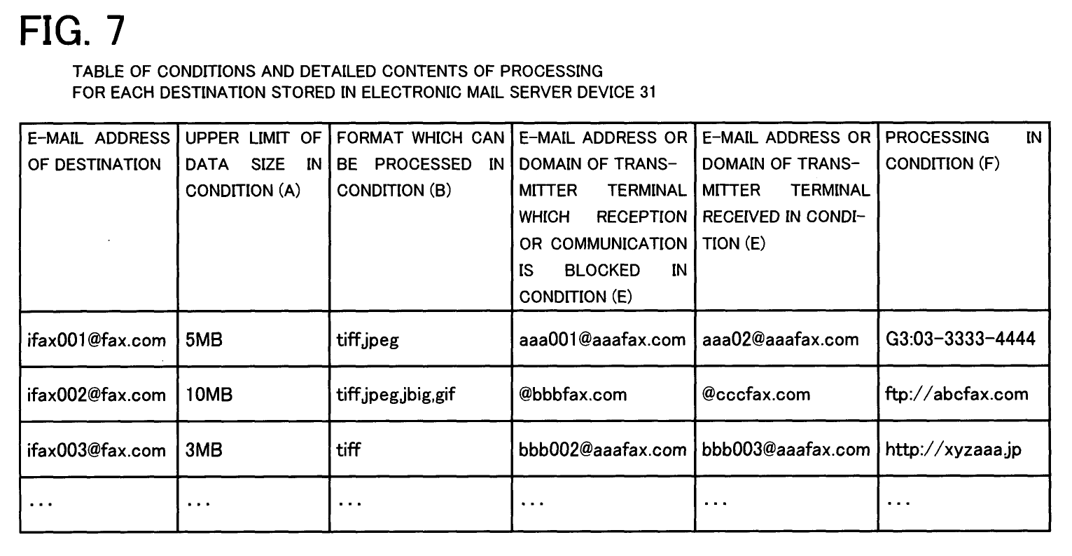

FIG. 6 shows an example of a table of conditions and processing which is stored in the electronic mail server device 31 of the second embodiment. FIG. 7 shows an example of a table of conditions and detailed contents of processing for each of destinations which is stored in the electronic mail server device 31 of the second embodiment. In the second embodiment, as shown in FIG. 6 and FIG. 7, when the processing condition satisfies at least one of the following conditions set in advance, the main control unit 101 executes at least one of the following processing set in advance.

(A) When a size of the received electronic mail or the attached file exceeds a prescribed value, at least one of the following processing is executed. That is, (a) divide the electronic mail and distribute the divided electronic mails, (b) forward the electronic mail to a destination which is different from an original destination (for example, a manager), (c) return the electronic mail to the transmitter terminal, or (d) print out the electronic mail or the attached file without forwarding. Further, as shown in FIG. 7, the size is preferable to be set for each electronic mail address of the destination. Moreover, the destination to which the electronic mail is forwarded is stored in the table of FIG. 7. Furthermore, a network printer connected to the LAN 70, or a printer in the electronic mail server device 31 can be used for printing the electronic mail or the attached file. Further, this description regarding the printing processing also applies below.

(B) When an attached file of the received electronic mail is not a specific format (format which can be processed shown in FIG. 7), at least one of the following processing is executed. That is, (a) convert the attached file into a prescribed format, and distribute the converted file, (b) forward the electronic mail to a destination which is different from an original destination (for example, a manager), (c) return the electronic mail to the transmitter terminal, or (d) print out the electronic mail or the attached file without forwarding. Further, the format is preferable to be set for each electronic mail address of the destination as shown in FIG. 7. In addition, the destination to which the electronic mail is forwarded is stored in the table of FIG. 7.

(C) When the received electronic mail is a specific type, at least one of the following processing is executed. That is, (a) forward the electronic mail to a destination which is different from an original destination (for example, a manager), (b) return the electronic mail to the transmitter terminal, or (c) print out the electronic mail without forwarding. Further, the specific type is, for example, an electronic mail which does not include image data, a reception confirmation mail, or a remote maintenance mail. It is preferable to exclude application of other conditions when receiving these electronic mails. Moreover, the destination to which the electronic mail is forwarded is stored in the table of FIG. 7.

(D) When specific data is included in the received electronic mail, at least one of the following processing is executed. That is, (a) remove the specific data from the electronic mail and distribute the electronic mail, (b) forward the electronic mail to a destination which is different from an original destination (for example, a manager), (c) return the electronic mail to the transmitter terminal, or (d) print out the electronic mail without forwarding. Further, the specific data is data including virus program. Moreover, the destination to which the electronic mail is forwarded is stored in the table of FIG. 7.

(E) When the transmitter terminal of the received electronic mail is a specific electronic mail address or a specific domain, at least one of the following processing is executed. That is, (a) forward the electronic mail to a destination which is different from an original destination (for example, a manager), (b) return the electronic mail to the transmitter terminal, (c) block the reception of the electronic mail, or (d) print out the electronic mail. Further, the specific electronic mail address or the specific domain is stored in the table of FIG. 7. Moreover, the destination to which the electronic mail is forwarded is stored in the table of FIG. 7. In addition, a condition can be set for when the transmitter terminal of the received electronic mail is not the specific electronic mail address or the specific domain, and processing for this condition can be defined.

(F) When failing to forward the received electronic mail, at least one of the following processing is executed. That is, (a) forward the electronic mail to a destination which is different from an original destination (for example, a manager), (b) return the electronic mail to the transmitter terminal, (c) print out the electronic mail without forwarding, (d) distribute the electronic mail again after an elapse of a prescribed period of time, or (e) distribute the electronic mail again via another communication channel or under another communication protocol. The processing of the condition (F) is stored in the table of FIG. 7. As shown in FIG. 7 as an example, a processing to forward the electronic mail again via another communication channel or under another communication protocol is a processing to transmit the electronic mail by using the public telephone line under a G3 facsimile protocol, or to transmit the electronic mail via the Internet under a File Transfer Protocol (FTP), or to transmit the electronic mail via the Internet by converting the electronic mail into a Hyper Text Transfer Protocol (HTTP) file.

(G) When receiving a plurality of divided electronic mails, the received plurality of divided electronic mails are restored into one electronic mail, and the restored electronic mail is forwarded.

Further, the main control unit 1 is preferable to obtain and receive the data including the processing condition and the processing corresponding to the condition, such as the data of the table shown in FIG. 7 or FIG. 8, from a remote device such as a server device of another electronic mail server device or the like under a prescribed communication protocol such as a Lightweight Directory Access Protocol (LDAP) which is a standard protocol for accessing to a directory service.

Specifically, when forwarding an electronic mail to a client terminal device such as the Internet facsimile machines 20A, 20B, 20C, the electronic mail server device 31 searches the receiving ability of the client terminal device by the directory service such as the LDAP. Then, the electronic mail server device 31 converts an electronic mail which cannot be analyzed by the client terminal device into a format which can be analyzed by the client terminal device, and forwards the converted electronic mail.

Moreover, when failing to transmit the electronic mail, the electronic mail server device 31 searches information of the destination from an electronic mail address of the destination in the directory service such as the LDAP. Then, when the electronic mail server device 31 succeeds in obtaining information of another communication protocol (facsimile number, a Uniform Resource Locator (URL), an address of the FTP, etc.), the electronic mail server device 31 automatically retransmits the electronic mail under the obtained communication protocol. Accordingly, the electronic mail server device 31 can easily obtain and receive these data, and can forward the electronic mail reliably.

<Third Embodiment>

In the above-described embodiments, an example of the Internet facsimile machines 20A, 20B, 20C is described. However, the present invention is not limited to such an example. For example, the present invention can be applied to a communication terminal device including a data communication device, a server device or the like which is connected to a public network such as a public telephone network or a public digital line network, or the Internet.

Moreover, the electronic mail protocol is not limited to the SMTP and the POP3.

In the above-described embodiments, the main control unit 101 executes the filtering processing of the electronic mail. However, the present invention is not limited to this example, and following processing can be executed under following processing condition.

That is, the processing can be executed when at least one of the following conditions or a combination of conditions is satisfied:

(a) the size of the received electronic mail or attached file is a prescribed size or larger (this prescribed size can be set for each server device or each destination) (or instead, the condition can be the size of the received electronic mail or attached file being a prescribed size or smaller, or the size of the received electronic mail or attached file being smaller than a prescribed size);

(b) the received electronic mail is a prescribed typed electronic mail (for example, it is preferable for other conditions to be exempted for a reception confirmation mail or a remote maintenance mail) (or instead, the condition can be the received electronic mail being not a prescribed typed electronic mail);

(c) the attached file of the received electronic mail is a prescribed format (the format can be set for each server device or each destination) (or instead, the condition can be the attached file of the received electronic mail being not a prescribed format);

(d) the received electronic mail includes inappropriate data (for example, data including virus) (or instead, the condition can be the received electronic mail not including inappropriate data);

(e) the received electronic mail is from an electronic mail address or a domain of a prescribed transmitter terminal (or instead, the condition can be the received electronic mail being not from an electronic mail address or a domain of a prescribed transmitter terminal); and

(f) the received electronic mail is addressed to an electronic mail address or a domain of a prescribed destination (or instead, the condition can be the received electronic mail being not addressed to an electronic mail address or a domain of a prescribed destination).

Moreover, the processing to be executed for the above condition is at least one of the following processing or a combination of the following processing:

(a) stop forwarding of the received electronic mail,

(b) return the received electronic mail to the transmitter terminal,

(c) forward the received electronic mail to the manager,

(d) execute conversion processing of the attached file of the received electronic mail into a file format which can be processed by the communication terminal device of the destination, and

(e) divide a main text or the attached file of the received electronic mail into sizes which can be processed by the communication terminal device of the destination.

What is claimed is:

1. An electronic mail server device comprising:
means for receiving an electronic mail;
means for determining whether a prescribed processing condition is satisfied in accordance with the received electronic mail; and
means for controlling to execute a prescribed processing to the received electronic mail when the processing condition is satisfied.

2. The electronic mail server device according to claim 1, wherein the prescribed processing condition is when a size of the received electronic mail or an attached file exceeds a prescribed value, and when the size of the received electronic mail or the attached file exceeds the prescribed value, the means for controlling executes at least one of following processing:
(a) dividing and forwarding the electronic mail;
(b) forwarding the electronic mail to a prescribed destination;
(c) returning the electronic mail to a transmitter terminal; and
(d) printing the electronic mail or the attached file.

3. The electronic mail server device according to claim 2, wherein the prescribed value of the size of the electronic mail or the attached file is a value specific to each electronic mail address or each domain of a destination of the electronic mail.

4. The electronic mail server device according to claim 1, wherein the prescribed processing condition is when an attached file of the received electronic mail is a specific format, and when the attached file of the received electronic mail is the specific format, the means for controlling executes at least one of following processing:
(a) converting the attached file into a prescribed format and forwarding;
(b) forwarding the electronic mail to a prescribed destination;
(c) returning the electronic mail to a transmitter terminal; and
(d) printing the electronic mail or the attached file.

5. The electronic mail server device according to claim 4, wherein the specific format is a format which is specific to each electronic mail address or each domain of a destination of the electronic mail.

6. The electronic mail server device according to claim 1, wherein the prescribed processing condition is when an attached file of the received electronic mail is not a specific format, and when the attached file of the received electronic mail is not the specific format, the means for controlling executes at least one of following processing:
(a) converting the attached file into a prescribed format and forwarding;
(b) forwarding the electronic mail to a prescribed destination;
(c) returning the electronic mail to a transmitter terminal; and
(d) printing the electronic mail or the attached file.

7. The electronic mail server device according to claim 6, wherein the specific format is a format which is specific to each electronic mail address or each domain of a destination of the electronic mail.

8. The electronic mail server device according to claim 1, wherein the prescribed processing condition is when the received electronic mail is a specific type, and when the received electronic mail is the specific type, the means for controlling executes at least one of following processing:
(a) forwarding the electronic mail to a prescribed destination;
(b) returning the electronic mail to a transmitter terminal; and
(c) printing the electronic mail.

9. The electronic mail server device according to claim 8, wherein the specific type is a type which is specific to each electronic mail address or each domain of a destination of the electronic mail.

10. The electronic mail server device according to claim 1, wherein the prescribed processing condition is when specific data is included in the received electronic mail, and when the specific data is included in the received electronic mail, the means for controlling executes at least one of following processing:
(a) removing the specific data from the electronic mail and forwarding the electronic mail;
(b) forwarding the electronic mail to a prescribed destination;
(c) returning the electronic mail to a transmitter terminal, and
(d) printing the electronic mail.

11. The electronic mail server device according to claim 1, wherein the prescribed processing condition is when a transmitter terminal of the received electronic mail is a specific address or a specific domain, and when the transmitter terminal of the received electronic mail is the specific address or the specific domain, the means for controlling executes at least one of following processing:
(a) forwarding the electronic mail to a prescribed destination;
(b) returning the electronic mail to the transmitter terminal;
(c) blocking a reception of the electronic mail; and
(d) printing the electronic mail.

12. The electronic mail server device according to claim 1, wherein the prescribed processing condition is when a transmitter terminal of the received electronic mail is neither a specific address nor a specific domain, and when the transmitter terminal of the received electronic mail is neither the specific address nor the specific domain, the means for controlling executes at least one of following processing:
(a) forwarding the electronic mail to a prescribed destination;
(b) returning the electronic mail to a transmitter terminal;
(c) blocking a reception of the electronic mail; and
(d) printing the electronic mail.

13. The electronic mail server device according to claim 1, wherein the prescribed processing condition is when failing to forward the received electronic mail, and when failing to forward the received electronic mail, the means for controlling executes at least one of following processing:
(a) forwarding the electronic mail to a prescribed destination;
(b) returning the electronic mail to a transmitter terminal;
(c) printing the electronic mail;
(d) forwarding the electronic mail again after an elapse of a prescribed period of time; and
(e) forwarding the electronic mail again via another communication channel or under another communication protocol.

14. The electronic mail server device according to claim 1, wherein the prescribed processing condition is when receiving a plurality of divided electronic mails, and when receiving the plurality of divided electronic mails, the means for controlling restores the received plurality of divided electronic mails into one electronic mail, and forward the electronic mail.

15. The electronic mail server device according to claim 1, wherein the means for controlling receives data which defines the processing condition and processing corresponding to the processing condition from a remote device under a prescribed communication protocol.

16. An electronic mail server device comprising:
a reception unit which receives an electronic mail;
a determination unit which determines whether a prescribed processing condition is satisfied in accordance with the received electronic mail; and
a control unit which executes a prescribed processing to the received electronic mail when the processing condition is satisfied.

17. An electronic mail processing method of an electronic mail server device, comprising:
receiving an electronic mail;
determining whether a prescribed processing condition is satisfied in accordance with the received electronic mail; and
executing a prescribed processing to the received electronic mail when the processing condition is satisfied.

18. The electronic mail processing method according to claim 17, wherein the prescribed processing condition is when a size of the received electronic mail or an attached file exceeds a prescribed value, and the prescribed processing is at least one of following processing:
(a) dividing and forwarding the electronic mail;
(b) forwarding the electronic mail to a prescribed destination;
(c) returning the electronic mail to a transmitter terminal; and
(d) printing the electronic mail or the attached file.

19. The electronic mail processing method according to claim 17, wherein the prescribed processing condition is when an attached file of the electronic mail is a specific format, and the prescribed processing is at least one of following processing:
(a) converting the attached file into a prescribed format and forwarding;
(b) forwarding the electronic mail to a prescribed destination;
(c) returning the electronic mail to a transmitter terminal; and
(d) printing the electronic mail or the attached file.

20. The electronic mail processing method according to claim 17, wherein the prescribed processing condition is when the received electronic mail is a specific type, and the prescribed processing is at least one of following processing:
(a) forwarding the electronic mail to a prescribed destination;
(b) returning the electronic mail to a transmitter terminal; and
(c) printing the electronic mail.

21. The electronic mail processing method according to claim 17, wherein the prescribed processing condition is when a specific data is included in the received electronic mail, and the prescribed processing is at least one of following processing:
(a) deleting the specific data from the electronic mail and forwarding;
(b) forwarding the electronic mail to a prescribed destination;
(c) returning the electronic mail to a transmitter terminal; and
(d) printing the electronic mail.

22. The electronic mail processing method according to claim 17, wherein the prescribed processing condition is when a transmitter terminal of the received electronic mail is a specific address or a specific domain, and the prescribed processing includes at least one of following processing:
(a) forwarding the electronic mail to a prescribed destination;
(b) returning the electronic mail to the transmitter terminal;
(c) blocking the reception of the electronic mail; and
(d) printing the electronic mail.

23. The electronic mail processing method according to claim 17, wherein the prescribed processing condition is when failing to forward the received electronic mail, and the prescribed processing is at least one of following processing:
(a) forwarding the electronic mail to a prescribed destination;
(b) returning the electronic mail to a transmitter terminal;
(c) printing the electronic mail;
(d) forwarding the electronic mail again after an elapse of a prescribed period of time; and
(e) forwarding the electronic mail again via another communication channel or under another communication protocol.

24. The electronic mail processing method according to claim 17, wherein the prescribed processing condition is when receiving a plurality of divided electronic mails, and the prescribed processing is restoring the received plurality of divided electronic mails into one electronic mail, and forwarding the electronic mail to a prescribed destination.
